(19) United States
(12) Patent Application Publication
(10) Pub. No.: US 2007/0011231 A1
(43) Pub. Date: Jan. 11, 2007

(54) Application and user interface for facilitating a meeting

(75) Inventors: Todd R. Manion, Redmond, WA (US); Sandeep K. Singhal, Kirkland, WA (US); Gursharan Sidhu, Seattle, WA (US); Simon Wong, Seattle, WA (US); Frederick Fourie, Seattle, WA (US); Ryan Kim, Sammamish, WA (US); Eliot Flannery, Redmond, WA (US); Peter Williamson, Kirkland, WA (US); Vladimir Bobov, Seattle, WA (US); Kanaka Komandur, Bellevue, WA (US); Scott Briggs, Redmond, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/175,547

(22) Filed: Jul. 6, 2005

(51) Int. Cl. G06F 15/16

(52) U.S. Cl. 709/204

(57) ABSTRACT

An application and its associated user interface provide a meeting window for use in organizing and holding meetings using peer-to-peer network facilities. The meeting window offers menu selections for choosing a network over which to hold the meeting and for discovering and inviting meeting participants. The meeting window includes three main panes, one each for managing attendees, for distributing files to attendees, and for streaming presentation materials real-time to attendees. Data streaming is also supported to network devices such as projectors. Control of the presentation may be delegated by the presentation owner to another attendee, and may also be revoked by the presentation owner. The real-time streaming of the presentation may be paused and resumed to accommodate meeting dynamics or real-time changes.

### BACKGROUND

Computers have been used in meetings for some time. Computers have been used to take meeting minutes or notes in real time. It is almost common practice now to use a computer and an attached projector when presenting information to a group at a meeting. Several attempts have been made, with varying success, to address meetings with remote participants. Initially, meeting participants would e-mail documents to all expected attendees for presentation during the meeting. Even when meeting attendees were co-located, distribution of files often required “sneaker-net” sharing with USB memory keys, etc. Presentations were synchronized by the leader's verbal instructions during a teleconference. Later, products such as Microsoft LiveMeeting allowed the use of presentation synchronization during the meeting and interactive tools such as an electronic white board would allow real-time interaction between users. However, these products are server-based and require a hosted environment for operation.

### SUMMARY

A user interface for starting meetings provides users with a simple interactive single-window mechanism for starting meetings, both computer-to-computer network based meetings and simple meetings with co-located attendees. An underlying application receives user input and manages attendee selection, file transfers, and presentations transparent to the user using peer-to-peer networking. A web server or meeting host is not required. Peer-to-peer networking infrastructure develops and manages the sharing and connectivity required to set up the links with meeting attendees and delivers the appropriate data streams to network resources associated with the attendees.

The meeting window includes three panes, one for selecting and managing users, another for sharing files between users, and a third for presenting data via a streaming service, such as a peer-to-peer network terminal service. A robust set of features for managing attendees, online presentation materials, and network presentation resources are made available through the meeting window menu selections.

### BRIEF DESCRIPTION OF THE DRAWINGS

FIG. 1 is a simplified and representative block diagram of a computer network;

FIG. 2 is a block diagram of a computer that may be connected to the network of FIG. 1;

FIG. 3 is a representation of a computer display meeting initiation icons;

FIG. 4 is a representation of a computer display showing attendee invitation selection;

FIG. 5 is a representation of a computer display showing a meeting window as other file icons;

FIG. 5a is a representation of the computer display of FIG. 5 showing menu picks for delegating control of a presentation to another attendee;

FIG. 5b is a representation of the computer display of FIG. 5 showing menu picks for revoking control of a presentation to the other attendee;

FIG. 5c is a representation of the computer display of FIG. 5 showing menu picks for pausing a presentation;

FIG. 5d is a representation of the computer display of FIG. 5 showing menu picks for leaving a meeting and saving shared files;

FIG. 6 is a representation of a computer display showing a “toast” invitation to a meeting;

FIG. 7 is a representation of a computer display showing a mini-mode version of the meeting window of FIG. 5; and

FIG. 8 is a method of starting, holding and ending an on-line meeting.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

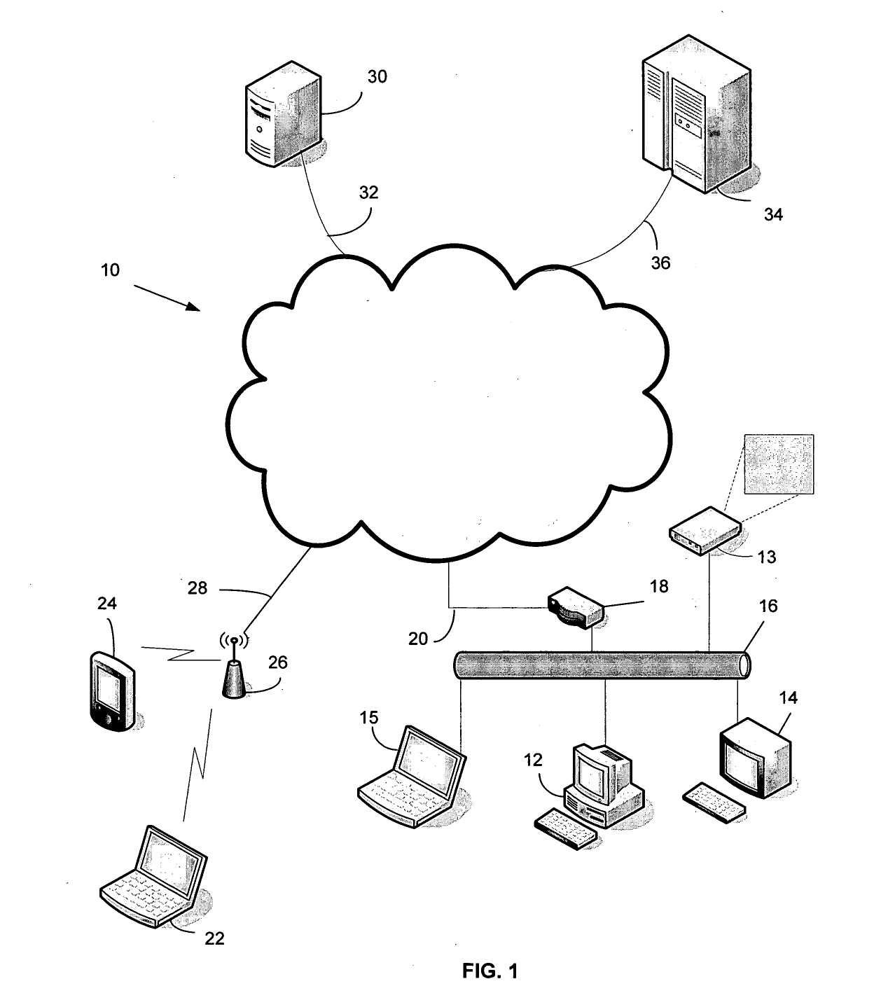

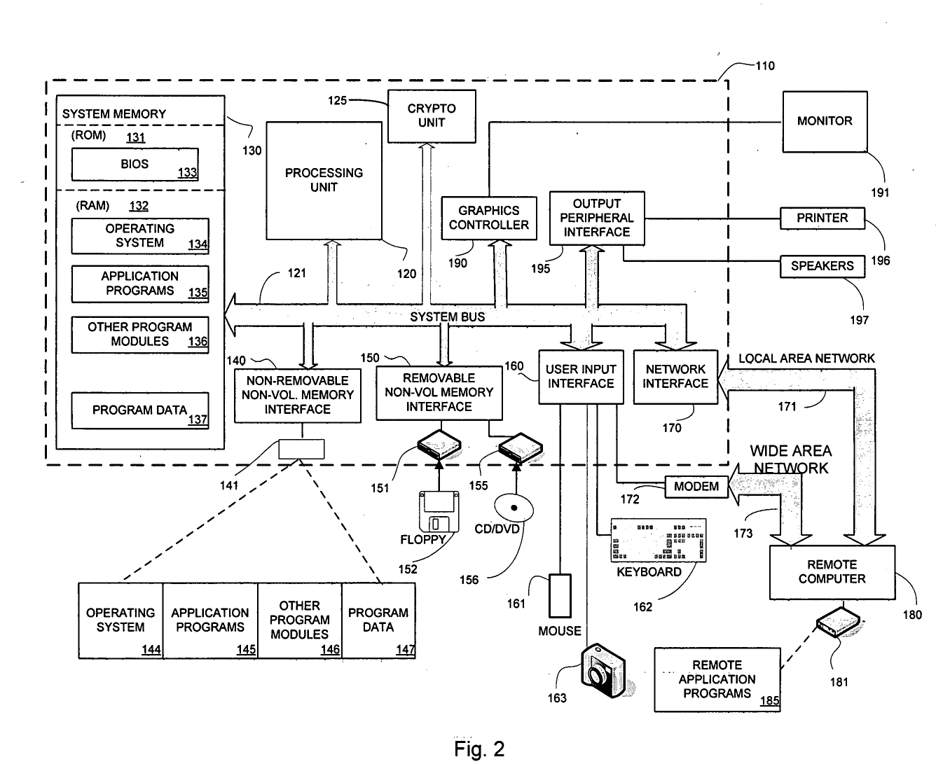

FIGS. 1 and 2 provide a structural basis for the network and computational platforms related to the instant disclosure.

FIG. 1 illustrates a network 10 that may be used to implement a dynamic software provisioning system. The network 10 may be the Internet, a virtual private network (VPN), or any other network that allows one or more computers, communication devices, databases, etc., to be communicatively connected to each other. The network 10 may be connected to a personal computer 12, a computer terminal 14, and a laptop 15 via an Ethernet 16 and a router 18, and a landline 20. The Ethernet 16 may be a subnet of a larger Internet Protocol network. Other networked resources, such as a projector 13, may also be supported via the Ethernet 16 or another data network. On the other hand, the network 10 may be wirelessly connected to a laptop computer 22 and a personal data assistant 24 via a wireless communication station 26 and a wireless link 28. Similarly, a server 30 may be connected to the network 10 using a communication link 32 and a mainframe 34 may be connected to the network 10 using another communication link 36. In one embodiment, the server 30 may function as a presentation server for serving presentation data on the network 10. In another embodiment, the mainframe 34 may function as a broadcast server to make available data to a large number of users, for example, corporate financial results presentations. The network 10 may be useful for supporting peer-to-peer network traffic.

FIG. 2 illustrates a computing device in the form of a computer 110. Components of the computer 110 may include, but are not limited to a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 may also include a cryptographic unit 125. Briefly, the cryptographic unit 125 has a calculation function that may be used to verify digital signatures, calculate hashes, digitally sign hash values, and encrypt or decrypt data. The cryptographic unit 125 may also have a protected memory for storing keys and other secret data. In addition, the cryptographic unit 125 may include an RNG (random number generator) which is used to provide random numbers. In other embodiments, the functions of the cryptographic unit may be instantiated in software or firmware and may run via the operating system or on a device.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/non-removable, volatile/nonvolatile computer'storage media. By way of example only, FIG. 2 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid, state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and cursor control device 161, commonly referred to as a mouse, trackball or touch pad. A camera, such as web camera 163 (webcam), may capture and input pictures of an environment associated with the computer 110, such as providing pictures of users. The webcam 163 may capture pictures on demand, for example, when instructed by a user, or may take pictures periodically under the control of the computer 110. Other input devices (not shown) may include a microphone, joystick, game pad, satellite dish, scanner, or the like. These and other input devices are often connected to the processing unit 120 through an input interface 160 that is coupled to the system bus, but may be connected by other interface and bus structures, such as a parallel port, game port or a universal serial bus (USB). A monitor 191 or other type of display device is also connected to the system bus 121 via an interface, such as a graphics controller 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181.

The communications connections 170 172 allow the device to communicate with other devices. The communications connections 170 172 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

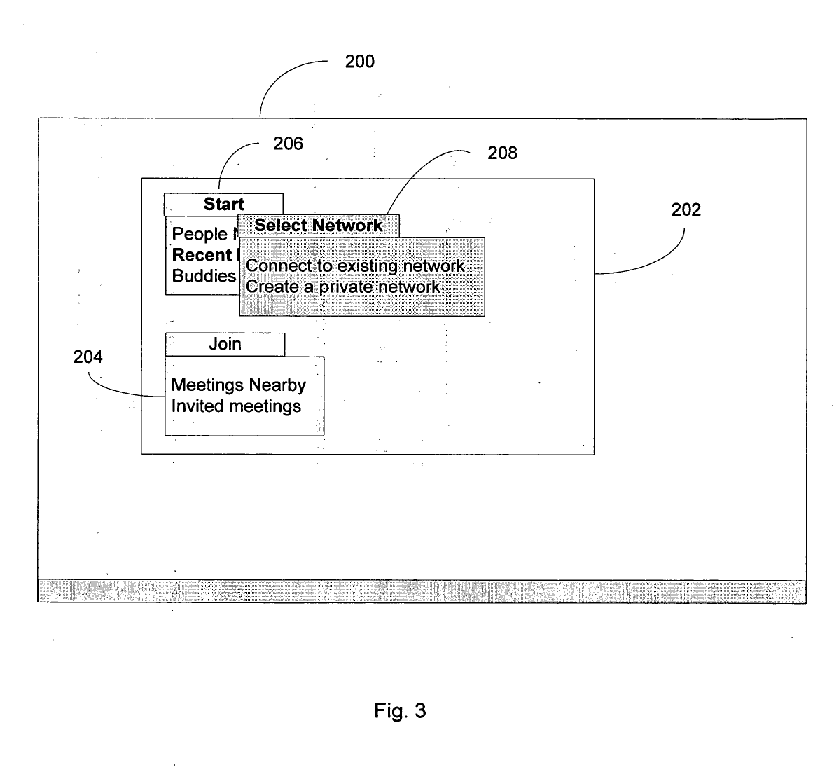

FIG. 3 depicts a computer display 200, such as the display of monitor 191 of FIG. 2. A unified activity window or simply, a meeting application window 202 may be used to launch, manage and end meetings or other network-based activities. The meeting application window 202 may have sub-windows and child windows as shown and described below. In one embodiment, a sub window 204 for joining a meeting may include selections for joining a meeting nearby that is in progress, or joining a meeting to which one has already been invited. Another sub window 206 may be used to start a meeting. When the start meeting sub window 206 is activated an additional sub window 208 may be provided for user selection of an appropriate network. For example, the meeting may be hosted on the local subnet, such as an Internet Protocol subnet depicted by subnet 16 of FIG. 1. In another embodiment, the user may choose to take advantage of peer-to-peer (ad hoc) network capabilities for discovering and joining networked resources in a private network.

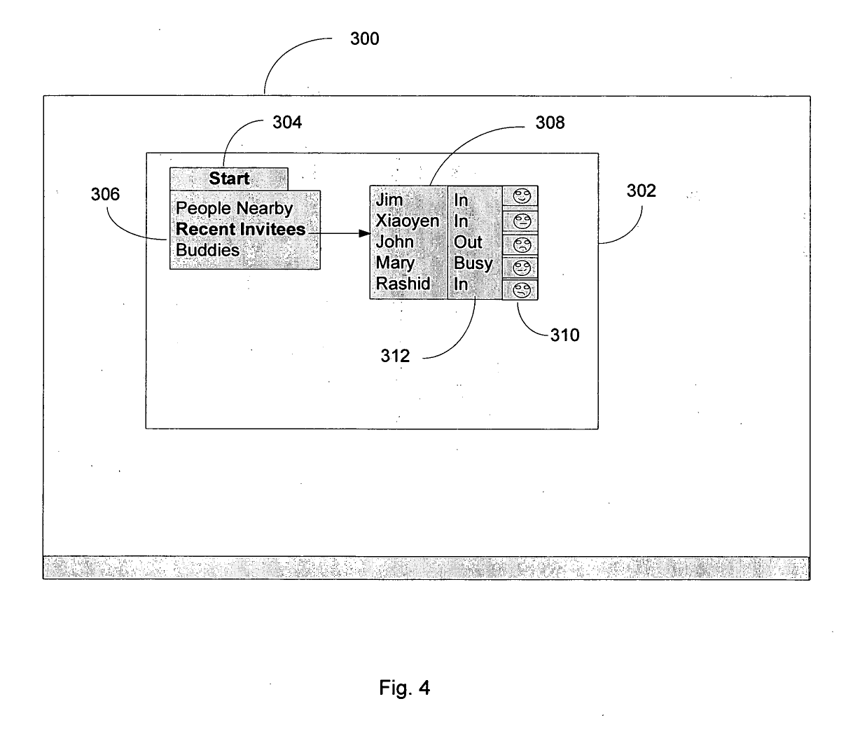

FIG. 4 depicts a computer display 300 similar to or the same as the computer display 200 of FIG. 3. After electing to start a meeting and selecting a network, a user may choose to invite participants using meeting window 302. Using a start meeting sub-window 304, the user may select individuals from groups identified in a sub-selection window 306. As depicted in FIG. 4, the user may highlight “Recent Invitees” and an attendee selection window 308 may be displayed from which the user can select one or more invitees. Similarly, sub-selection window 306 may be used to offer names from a buddy list or people who are nearby, for example, who have computers on the same Internet Protocol subnet as the user, on the same ad hoc wireless network. Proximity may even be determined by empirically, for example, using, global positioning system (GPS) data. Icons 310 corresponding to user identity and indicia 312 corresponding to current status, such as those used in instant messaging programs, may be used to indicate participant status and therefore the likelihood of their attending an ad hoc meeting.

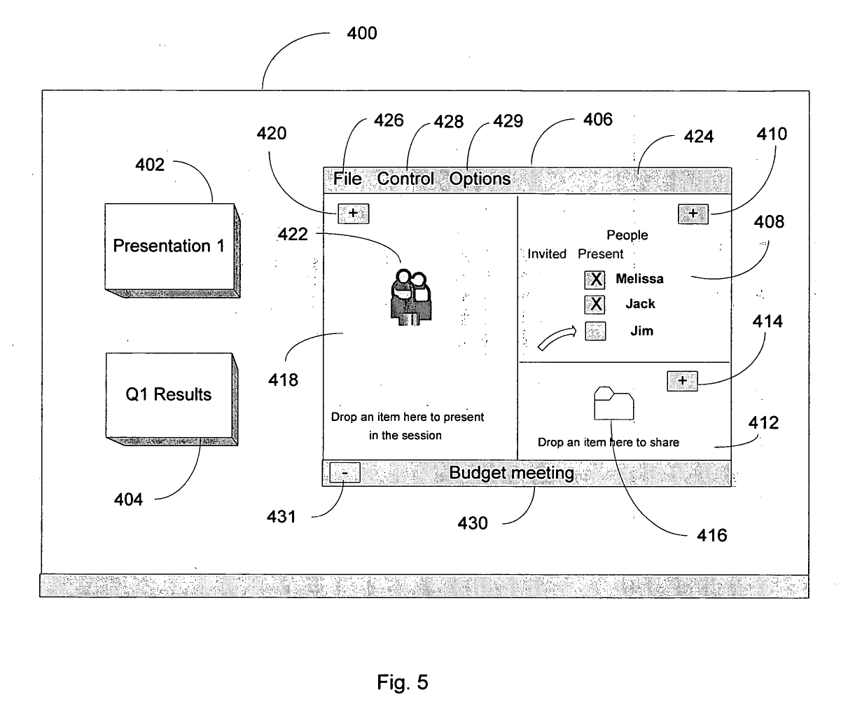

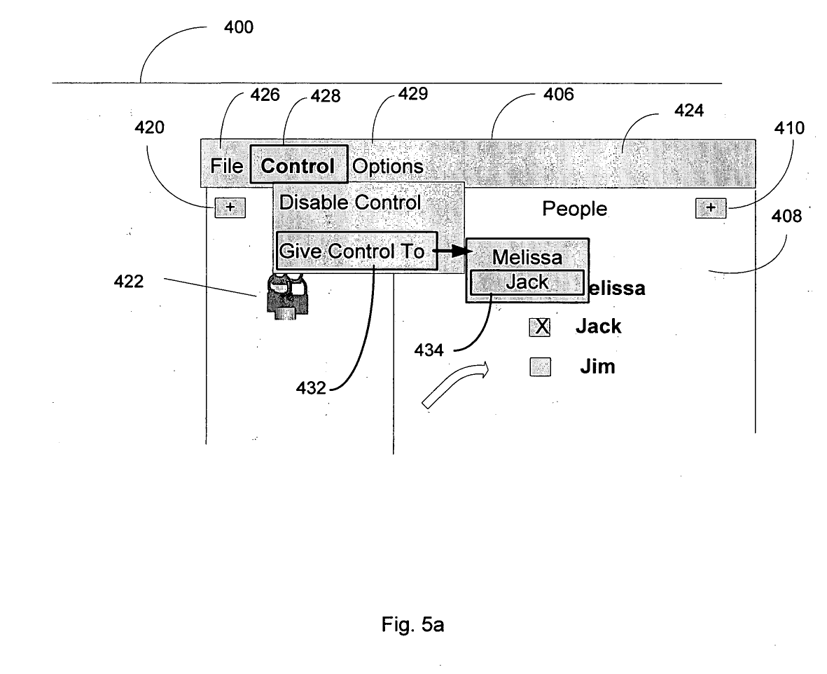

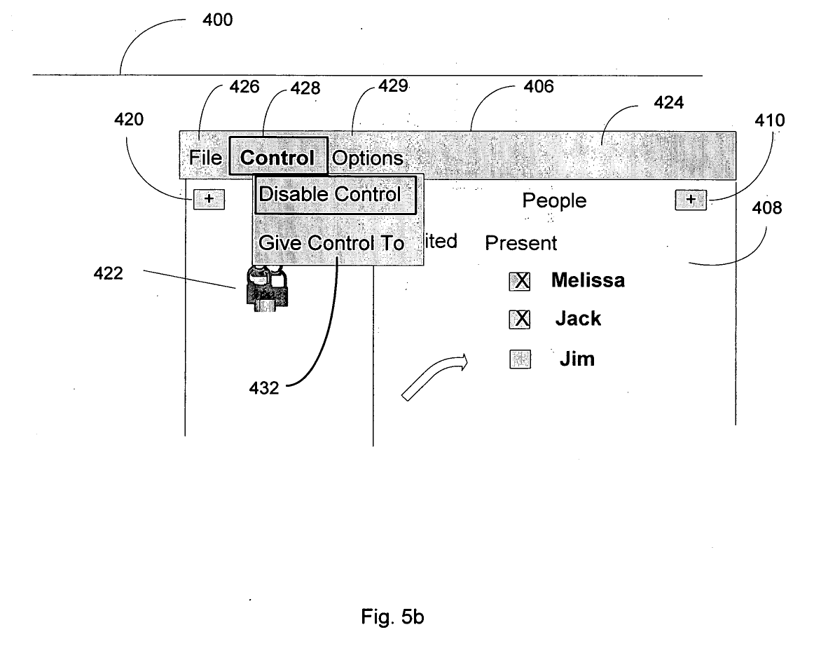

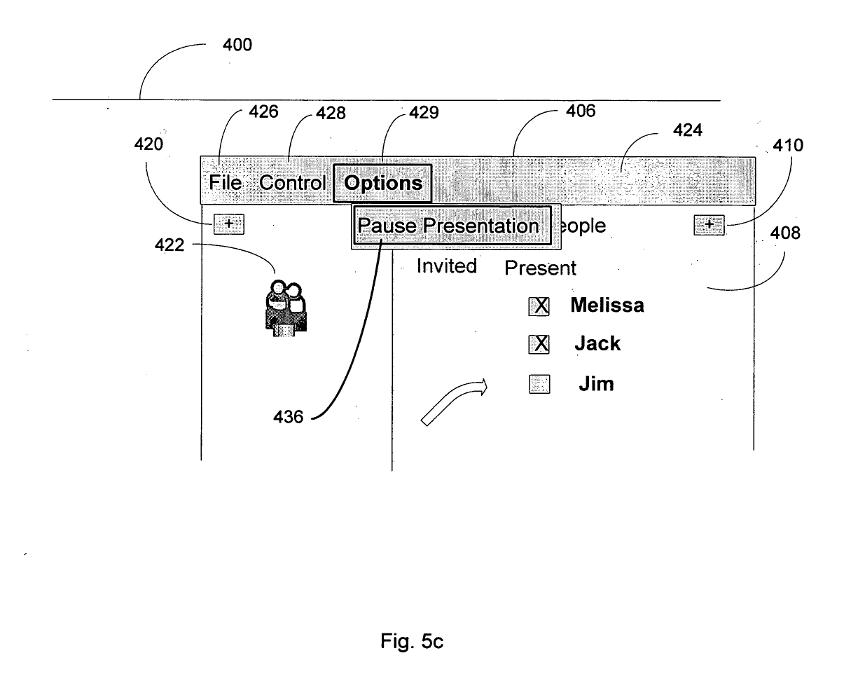

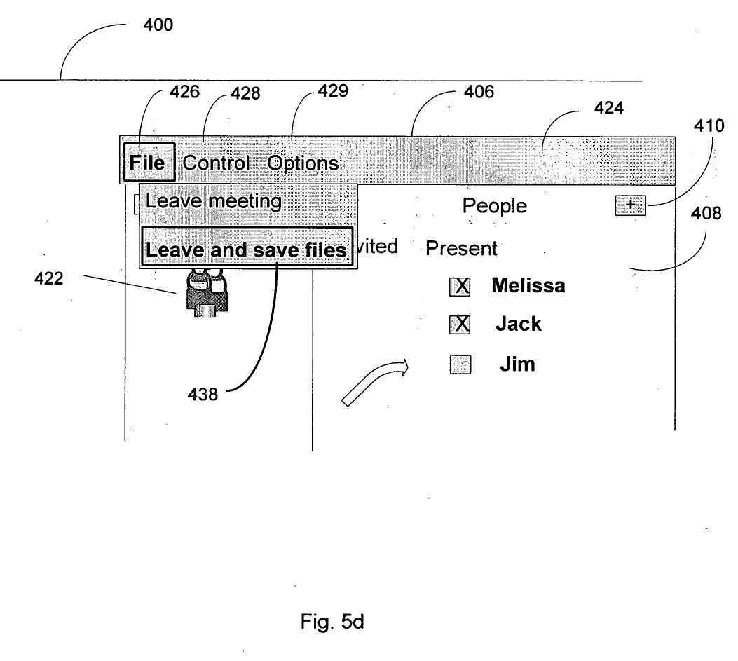

FIG. 5 depicts a computer display 400 similar to or the same as computer display 200 of FIG. 2. Icons representing files 402 404 may be present on the display 400. As shown, icon 402 may represent a presentation, for example, a Microsoft PowerPoint™ presentation, while icon 404 may represent a document, for example, a Microsoft Word™ file. A meeting window 406, the same as or a successor to meeting application window 202 of FIG. 2, may include several panes and bars. An attendee pane 408 may include a selection icon 410 and attendee status information. In the exemplary embodiment depicted in FIG. 5, the attendee pane 408 shows that attendees Melissa and Jack have joined the meeting, as indicated by the checks in the boxes next to their names. A third invitee Jim is not present as indicated by the arrow in the invited column next to the box for Jim's name. In another embodiment, status icons 312 and user identity icons 310 such as those shown in FIG. 4, may also be present. Activating the selection icon 410 may produce another window such as FIG. 4 meeting window 302 for selection of additional meeting attendees.

A sharing pane 412 may include a selection icon 414 and a drag-and-drop icon 416. Activating the selection icon 414 may produce a normal file selection dialog box for navigating to a folder and selecting one or more files. Similarly, one or more files may be dragged onto the drag-and-drop icon 416. The effect of file selection or dragging and dropping is to distribute the files to each attendee over a peer-to-peer network connection, according to an underlying file sharing protocol. The files may be physically copied or distributed using a metadata publish/ask model. Files made available by other meeting participants may be shown in the sharing pane 412 by file icons (not depicted). At the conclusion of a meeting the user may select to keep a copy of the shared files or to have the shared files discarded.

A presentation pane 418 may include a selection icon 420 and a drag-and-drop icon 422. As discussed in more detail in a co-pending patent application (Attorney Docket number 30835/313456), the presentation pane 418 may be used to launch presentations on networked devices, including the computers of meeting attendees and presentation equipment, for example, computers 12 and 15 and projector 13 of FIG. 2. Dragging and dropping a file onto the meeting icon 422 or by opening a file selection dialog using selection icon 420 may be used to present data to attendees by streaming data to their computers or other display devices over the peer-to-peer network.

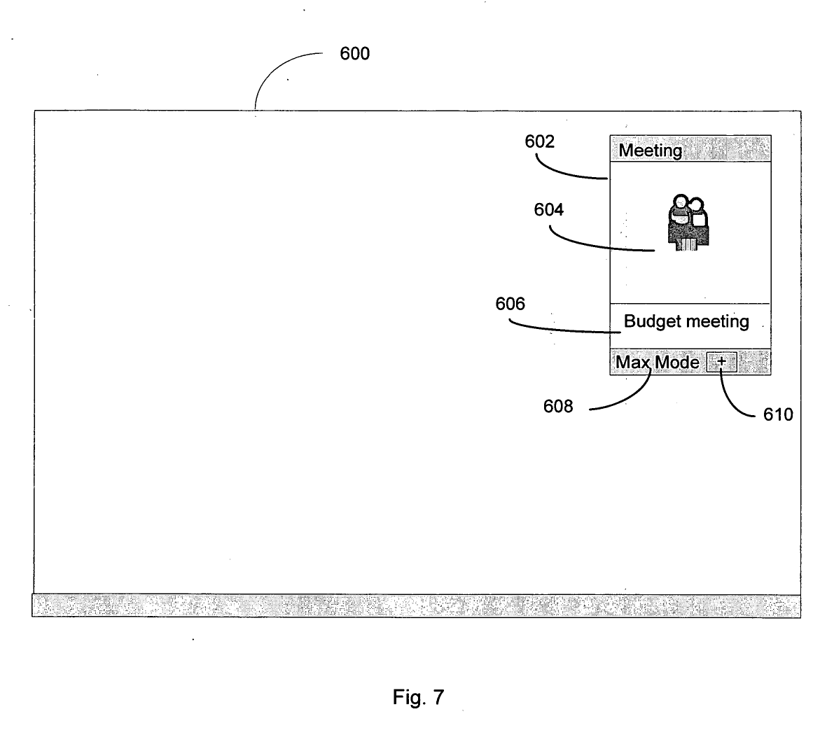

A menu bar 424 may include file 426 and control 428 menu selections used for advanced control of the meeting process. A status bar 430 may display a meeting title, as shown, or other information regarding the meeting, for example, current status information such as “distributing files.” The minimize icon 431 may be used to reduce the three pane meeting window 406 to a smaller size, and as discussed more with respect to FIG. 7.

FIG. 5a depicts a close-up view of a portion of the computer display 400 of FIG. 5. Shown is a menu selection for enabling a remote user to control presentation materials presented by another user. In this exemplary embodiment, the control menu item 428 may be selected to present a drop-down menu 432. The “give control to” menu item may be selected, activating an additional drop-down or pop-up menu 434 showing the names of current attendees. In this example, control is given to Jack who may then manage all aspects of the presentation as if he had initiated it. Again, in this exemplary embodiment, Jack may retain control until the presentation is finished and closed. Alternately, the original presenter may revoke the control given to Jack. Referring to FIG. 5b, the control menu item 428 may be selected, activating the drop-down menu 432 from which the “disable control” menu selection may be made. Jack's control may be revoked and control of the presentation returned to the original presenter. In general, all peers of the peer-to-peer network in the meeting may be considered generally equal in all respects, with one exception being this ability for the presentation initiator to disable control once granted.

FIG. 5c similarly depicts a close-up view of a portion of the computer display 400 of FIG. 5. When streaming presentation materials live to attendees, it may be useful for the presenter to pause a presentation, that is, to temporarily halt the data stream associated with the presentation. For example, the presenter may see an item requiring a change or a discussion may have moved away from the subject of the currently displayed material. The presenter may select menu bar item “Options” 429 to reveal a drop-down box 436 giving the option to pause the presentation. The presenter may then make any desired adjustments or complete the discussion and resume the presentation using the same menu selections. While the presentation is paused, other meeting participants may see either a still-frame image of the presentation or a blank image.

FIG. 5d also depicts a close-up view of a portion of the computer display 400 of FIG. 5. At the conclusion of a meeting, or any time when an attendee chooses to leave the meeting, he or she may activate the “File” menu item 426. A drop-down box 438 provides the attendee with an opportunity to leave the meeting, or leave while retaining a copy of any presentation materials that were transferred during the course of the meeting.

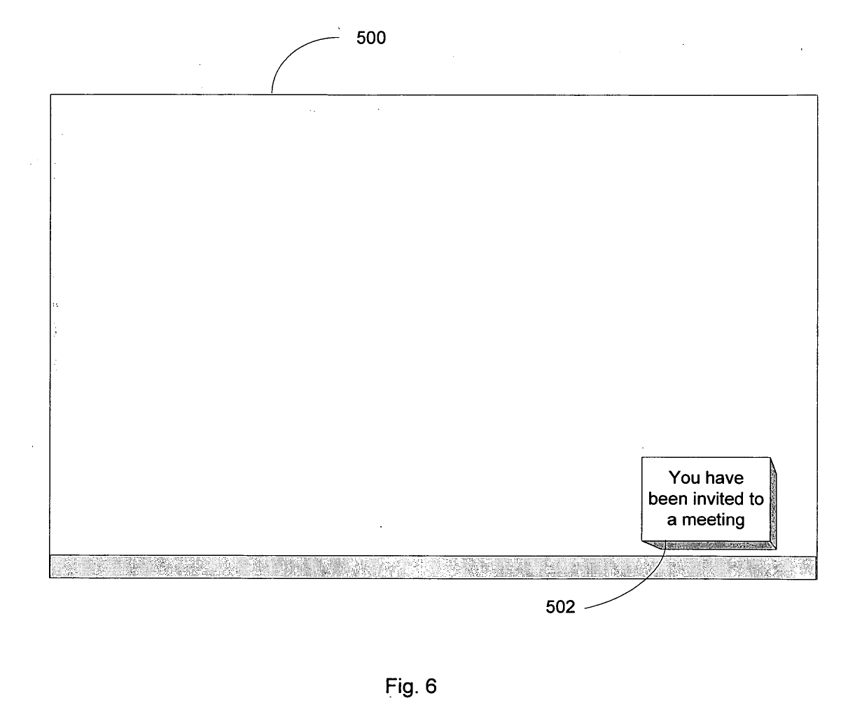

FIG. 6 depicts a computer display 500, the same as or similar to computer display 200 of FIG. 3. When being invited to a meeting, an invitation in the form of a small window may pop up from an edge of the computer display 500. The small window is commonly referred to as “toast” because of how it pops out. The toast invitation 502 may be used to identify the meeting organizer and title. The invitee may click on the toast invitation 502 to activate a meeting window, such as meeting window 406 shown in FIG. 5 and subsequently join the meeting, for example, using the “Join Meeting” icon 204 of FIG. 3. After a period, the toast message may disappear. A notification flag, or icon may be substituted on a taskbar or other display real estate for use in joining the meeting after the toast is gone.

FIG. 7 depicts a computer display 600 representing a display associated with a meeting attendee. In the course of a meeting, an attendee who is not fully engaged in the process may wish to limit his or her participation, perhaps to attend to other activities. By using the minimize icon 431 of FIG. 5, the attendee may reduce the meeting window 406 to a monitoring window 602. The monitoring window 602 may include a presentation pane 604, for monitoring any presentation materials currently active, a title bar and event notification list 606, and a maximize bar 608. The maximize bar may include a maximize icon 610 for use in returning the monitoring window 602 to the full-size meeting window 406.

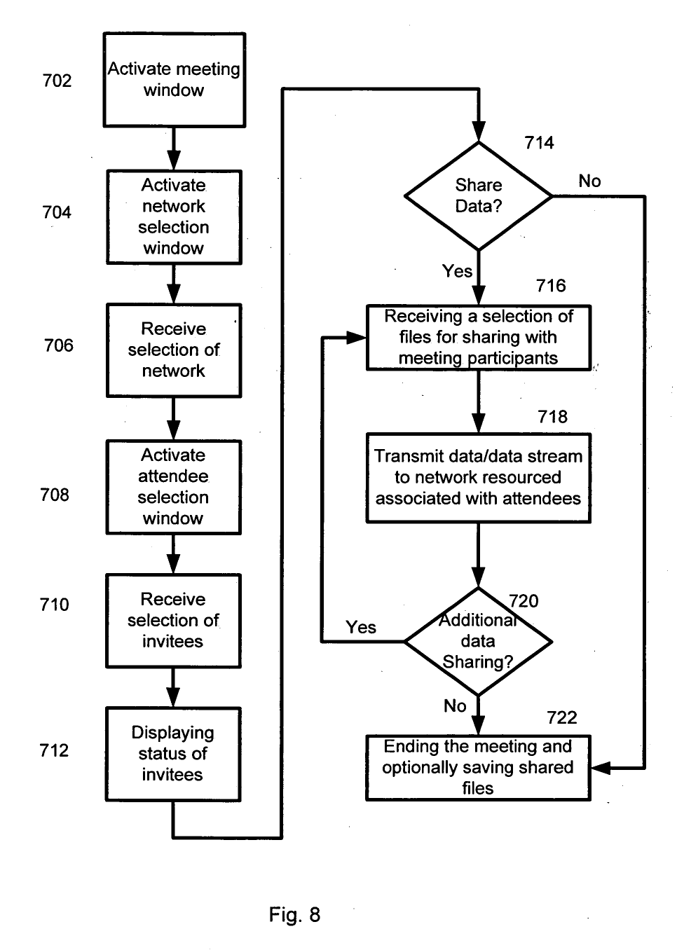

FIG. 8, an exemplary method of holding an online meeting over a peer-to-peer network is discussed and described. When a computer user has decided to hold a meeting, he or she may activate 702 a meeting window. They may then activate 704 a window for network selection. A variety of network selections may be available. For example, computers, and therefore their associated users, present on a local network such as a local Internet Protocol (IP) subnet may be displayed for selection. The use of an IP subnet for providing a selection of meeting attendees relies on the notion that in many cases the physical topology of a network follows the organization of the people on the network. Alternatively, in one embodiment, network selection may take advantage of “talk-around” capability in wireless network products. Such capability allows nearby users to form their own private networks without regard to a larger network infrastructure, such as wireless access points, backbones and routers.

When a selection of network is received 706 an attendee selection window may be activated 708. Attendees may be selected from a variety of groups or lists of individuals. For example, a buddy list used for Instant Messaging (IM) may provide names for selection. Personal, local, and network-based, for example corporate, address books may be used to supply names for selection. Additional selections may be made from persons recently invited to other meetings. After receiving 710 the selection of users, invitations, such as toast messages, may be forwarded to the invitees. As shown in FIG. 5 pane 408, invitee status may be displayed 712, showing those in attendance, those who have not arrived, or those who have declined (not depicted).

Once the meeting is active, multiple activities may be performed. Often it is desirable to distribute materials to meeting participants. The application associated with the meeting may provide, as discussed above, the capability to receive 714 a selection of whether to share data or files with meeting participants. If the choice is to share files, the ‘yes’ branch of block 714 may be followed. A selection of files for sharing may be received 716 by the application. The selection may be for distribution of files or for streaming of presentation data. Familiar menu pick or drag-and-drop methods are two examples of ways to introduce files for sharing with meeting participants. Once identified, known peer-to-peer network services, such as a file replication service, may be used to distribute 718 the selected data to current participants as well as updating newly added participants. When the selection is to stream presentation data, an appropriate application program may be activated, if needed, and output data associated with the presentation may be distributed 718 to participating computers. In addition, certain network devices such as network accessible projectors may also be designated as targets of the presentation data stream. If additional presentation materials or data files are to be shared, the ‘yes’ branch from block 720 may be followed and the process repeated.

If no data is shared at block 714, the ‘no’ branch may be followed to block 722. Similarly, when no more data is to be shared, the ‘no’ branch from 720 may be followed to block 722. The meeting may proceed as normal to a conclusion.

At the conclusion of the meeting (or earlier), participants may leave 722 the meeting. Participants may have the opportunity to save any files that were shared during the meeting process or alternatively to discard those files to limit the possibility of version confusion in the future.

The meeting application described and its associated user interface bring new features and capabilities to meeting organizers and meeting attendees. The simple organization of the meeting window and special function panes reduce the overhead associated with inviting, attending, sharing files, and presenting live data during a meeting. The use of peer-to-peer network data streaming for presentations greatly simplifies the processes currently available for viewing presentation materials.

Although the foregoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

1-20. (canceled)

21. A computer-readable medium having computer-executable instructions for presenting and managing a meeting comprising:
presenting a first selection window for receiving input corresponding to one of joining a meeting or starting a meeting;
presenting a second selection window for receiving input corresponding to a network selection;
presenting a meeting window having at least three panes for supporting the meeting;
selecting at least one file for display to at least one meeting attendee; and
directing data corresponding to the at least one file to a peer-to-peer network for presentation of the data to the at least one meeting attendee.

22. The computer-readable medium of claim 21, wherein the presenting the meeting window having at least three panes comprises presenting the meeting window having a first pane for selecting and showing attendees, a second pane for sharing a file, and a third pane for selecting and displaying presentation materials.

23. The computer-readable medium of claim 22, wherein the presenting the meeting window having at least three panes further comprises presenting the meeting window having a status bar and a menu bar, wherein the status bar is operable to display a meeting title, and the menu bar is operable to display meeting options.

24. The computer-readable medium of claim 22, wherein the first pane for selecting and showing attendees comprises a list of invitees, each invitee having an icon representing the invitee's identity, and an icon representing a status for each invitee.

25. The computer-readable medium of claim 22, wherein a shared file is made available via the second pane.

26. The computer-readable medium of claim 22, wherein the second pane for sharing files comprises a means for designating a file, wherein the file designated is made available to other meeting attendees.

27. The computer-readable medium of claim 26, wherein the means for designating the file comprises at least one of a first icon onto which files may be dragged and dropped and a second icon for activating a file selection menu.

28. The computer-readable medium of claim 21, further comprising presenting a selection of nearby users for inviting to the meeting.

29. The computer-readable medium of claim 28, wherein the nearby users comprise computers on the same Internet Protocol subnet.

30. The computer-readable medium of claim 21, further comprising presenting an invitation to a meeting via a toast message.

31. The computer-readable medium of claim 21, further comprising authorizing a remote user to control the presentation materials.

32. The computer-readable medium of claim 31, further comprising revoking the remote user's control of the presentation materials.

33. The computer-readable medium of claim 21, further comprising pausing the data directed to the peer-to-peer network.

34. The computer-readable medium of claim 21, further comprising presenting an reduced size mode of the meeting window.

35. The computer-readable medium of claim 21, further comprising presenting a dialog for saving shared files at the conclusion of a meeting.

36. A method of holding an on-line meeting over a peer-to-peer network comprising:
presenting a meeting window having three meeting panes, a status bar, and a menu bar;
receiving a selection of a network for communicating with a networked device;
receiving a selection of network devices corresponding to people from at least one of a locally maintained contact list, a local address book, a network address book, or nearby devices; and
directing data corresponding to meeting activity to the selected network devices.

37. The method of claim 36 further comprising selecting a networked presentation device.

38. The method of claim 36 wherein the three meeting panes comprise a participant window for viewing the status of meeting invitees, a file sharing pane for initiating file sharing between meeting participants, and a presentation pane for initiating streaming of data over a peer-to-peer network for display at a networked device associated with meeting participants.

39. A computer having a user interface adapted for use in an on-line meeting using a peer-to-peer network protocol comprising:
an activity window comprising three panes, a status bar, and a menu bar, the first pane for selecting attendees, the second pane for file sharing, the third pane for selecting data for display to meeting participants, the activity window further comprising a series of sub-windows:
a first sub-window for selecting meeting attendees, the second sub-window activated responsive to a selection in the first pane;
a second sub-window for inviting meeting participants; and
a third sub-window for ending the meeting.

40. The computer of claim 39, further comprising:
a menu selection available from the menu bar for passing control to a meeting attendee of the data for display to meeting participants; and
a menu selection available from the menu bar for revoking control to a meeting attendee of the data for display to meeting participants.
